(19) United States
(12) Patent Application Publication
(10) Pub. No.: US 2025/0104949 A1
(43) Pub. Date: Mar. 27, 2025

(54) HIGH-FREQUENCY RELAY WITH EXCELLENT SHIELDING PERFORMANCE

(71) Applicant: XIAMEN HONGFA SIGNAL ELECTRONICS CO., LTD., Xiamen (CN)

(72) Inventors: Xinping LIAN, Xiamen (CN); Jiabin LIN, Xiamen (CN); Xinshang DONG, Xiamen (CN); Junqing LIN, Xiamen (CN)

(21) Appl. No.: 18/724,680

(22) PCT Filed: Dec. 26, 2022
(86) PCT No.: PCT/CN2022/142050

§ 371 Date: Jun. 27, 2024

(30) Foreign Application Priority Data
Dec. 30, 2021 (CN) 202111665354.4
Dec. 30, 2021 (CN) 202111665355.9

(51) Int. Cl. H01H 50/04; H01H 50/16; H01H 50/24; H01H 50/44; H01H 50/54

(52) U.S. Cl. CPC H01H 50/045; H01H 50/163; H01H 50/24; H01H 50/44; H01H 50/546; H01H 2050/446

(57) ABSTRACT

A high-frequency relay with excellent shielding performance includes a magnetic circuit part, a base part, and movable contact part. The base part includes an upper and a lower ground shield pieces, at least two static contact pieces, and a plastic body combining the lower grounding shield piece and the static contact pieces into an integrated structure through an injection molding; each of the static contact pieces has a contact for contacting with the movable contact part, a top surface of the contact is higher than an upper surface of the lower grounding shield piece; the upper grounding shield piece is mounted on the plastic body and is higher than the top surface of the contact and is grounded through the lower grounding shield piece; a shielding space that is grounded above and below at the portion for transmitting signals inside the relay.

### CROSS-REFERENCE TO RELATED APPLICATIONS

The present disclosure is a national stage application of International Application No. PCT/CN2022/142050 entitled “High-Frequency Relay with Excellent Shielding Performance,” filed on Dec. 26, 2022, which claims the benefit of and priority to Chinese Patent Application No. 202111665355.9 and Chinese Patent Application No. 202111665354.4 filed on Dec. 30, 2021, the disclosures of all of which are hereby incorporated by reference in their entireties herein.

### TECHNICAL FIELD

The present disclosure relates to the technical field of a relay and, particularly, to a high-frequency relay with excellent shielding performance.

### BACKGROUND

A high-frequency relay is used to switch high-frequency circuits. Due high-frequency signal transmission requirements, it is necessary to arrange a shielding structure inside or outside the relay. One type of high-frequency relay in existing technology includes a base fully made of metal, where the base is divided into an upper base and a lower base, both of which being made of metal materials. The spring pieces are combined on the lower base through an injection molding, and assembled as the base by welding the upper and lower bases. Then, the base is welded with a metal shell into a whole, followed by grounding through grounding pins of the shell. The upper and lower bases of the high-frequency relay form grounding shields, and the high-frequency signals are transmitted in a shielding space, providing good shielding effect. However, there are several drawbacks.

First, a metal upper base, a metal lower base, and a metal shell have complex and difficult forming processes and require secondary processing. Second, the metal upper base and the metal lower base are processed, and then further combined with a static contact band by an injection molding to provide some insulating capability between the static contact band and the metal base, resulting in lower product insulation capability, and component units of the base and static contact band combined by the injection molding have high process difficulty and lower dimensional accuracy. Third, the grounding pin cannot be directly integrated with the metal base, and the metal base needs to be grounded further by welding with the metal shell, it is limited to the process requirements of sealing the shell and the base by gluing, the gap between the shell and the base is very small, and the welding reliability of the metal shell and the base is poor.

Fourth, the process is complex, and the production efficiency is low, the production process requires: forming the upper and lower metal bases→combining the lower metal base with the static contact band by the injection molding→assembling the upper and lower bases by welding→assembling the base and the shell by welding→sealing by a glue. Fifth, a binding force between the metal and the sealing glue is poor, which is prone to a significant decrease in the sealing performance of the relay after reflow soldering.

Another type of high-frequency relay in existing technology is a solution of a base made of plastic by an injection molding, where the static contact band is combined with the plastic by the injection molding to form the base part, and a grounding shield strip is provided on the base part or a single edge above, forming a strip-shaped transmission structure. This type of high-frequency relay has the base that has relatively simple forming process, is easy to implement, and has good processing accuracy and low material cost. Compared with the traditional metal base, the plastic base has a better binding force with a sealing glue, and the overall sealing performance of the finished relay is better. However, the problem with this type of high-frequency relay is that the upper and lower bases do not form a shielding space corresponding to a portion for transmitting signals inside the relay, resulting in poor shielding effect, which cannot meet high-frequency relay use requirements. It is also necessary to add metal shielding parts outside the relay to further enhance the shielding effect, and, when used in a client side, a complete grounding structure must be provided on a PCB board to form an upper and lower shielding structure to a certain extent.

### SUMMARY

A high-frequency relay with excellent shielding performance includes a magnetic circuit part, a base part, and a movable contact part. The magnetic circuit part and the movable contact part are respectively mounted on the base part and achieving mutual linkage, in which the base part includes an upper grounding shield piece, a lower grounding shield piece, at least two static contact pieces, and a plastic body combining the lower grounding shield piece and the at least two static contact pieces into an integrated structure through an injection molding. Each of the static contact pieces has an exposed portion exposed from a surface of the plastic body, and the exposed portion has a contact for contacting with the movable contact part, a top surface of the contact is higher than an upper surface of the lower grounding shield piece in a height direction. The upper grounding shield piece is mounted on the plastic body and is higher than the top surface of the contact in the height direction and is grounded through the lower grounding shield piece, so that a shielding space is formed in the base part, and the shielding space is constituted by a gap between the upper grounding shield piece and the lower grounding shield piece and is capable of accommodating a bridge-type movable contact piece in the movable contact part.

The plastic body is provided with a groove, the exposed portion of the static contact piece is at a bottom surface of the groove and is exposed from the bottom surface of the groove of the plastic body, and the upper grounding shield piece is mounted in the groove of the plastic body.

The lower grounding shield piece and the at least two static contact pieces are formed by stamping one strip material, and the lower grounding shield piece and the static contact pieces are combined into the plastic body co-planarly through the injection molding, so that the lower grounding shield piece and the static contact pieces form a position complementarity in a plane area.

The plastic body is a block in a cuboid shape, a periphery of the plastic body extends upward to form side walls and the side walls form the groove; the lower grounding shield piece and at least two static contact pieces are co-planarly exposed from the bottom surface of the groove of the plastic body.

In the groove of the plastic body, in a covering area corresponding to the lower grounding shield piece, a plurality of support blocks integrally connected to the plastic body are provided, the plurality of support blocks respectively cover areas corresponding to the lower grounding shield piece; the upper grounding shield piece is placed on the plurality of support blocks; a top surface of the side wall is higher than a top surface of the upper grounding shield piece.

The plurality of support blocks include first support blocks respectively at four corners of the groove of the plastic body and second support blocks on two long sides of the plastic body in rectangular shape; in the lower grounding shield piece, solder pieces extending to two sides are provided, the solder pieces are bent upwards and top surfaces of the solder pieces are exposed from a top surfaces of the second support blocks, and the upper grounding shield piece is welded and fixed at a corresponding position with the solder pieces.

In long side walls corresponding to the plastic body in a rectangular shape, notches are further provided at a position corresponding to the second support blocks, the solder pieces of the lower grounding shield piece extend to the notches, and a height of the top surface of the solder piece in the notch is aligned with a height of the top surface of the second support block; in the upper grounding shield piece, positioning protrusion pieces integrally extended at a positions corresponding to the notches of the plastic body are provided, and the positioning protrusion pieces of the upper grounding shield piece are fit into the notch of the plastic body and are welded and fixed with the solder piece.

The lower grounding shield piece and the at least two static contact pieces are respectively provided with grounding pins or leading-out pins extending outward from a side surface of the plastic body; wherein the grounding pins of the lower grounding shield piece comprises at least four grounding pins distributed at four corners of the plastic body in a rectangular shape.

The movable contact part includes at least one bridge-type movable contact piece linked with the magnetic circuit part and an elastic resetting piece for resetting the bridge-type movable contact piece; the bridge-type movable contact piece is in the gap between the upper grounding shield piece and the lower grounding shield piece, two ends of the bridge-type movable contact piece respectively correspond to the contacts of two static contact pieces of at least two static contact pieces, a lower end of the elastic resetting piece is abuts against the lower grounding shield piece, such that an upper end of the elastic resetting piece in a resetting process pushes the bridge-type movable contact piece to the upper grounding shield piece.

The magnetic circuit part includes a coil part and an armature part that cooperate with each other; the coil part is mounted on the plastic body, and the armature part is supported by the upper grounding shield piece; the upper grounding shield piece is integrally connected to an armature support seat through the injection molding; there are two armature support seats respectively in a middle position of the two long sides of the upper grounding shield piece.

The at least two static contact pieces comprise two normally opened end static contact pieces, two common end static contact pieces, and two normally closed end static contact pieces respectively on two sides in a length direction of the plastic body in rectangular shape; the two common end static contact pieces are in a middle portion of the plastic body, and the two normally opened end static contact pieces and the two normally closed end static contact pieces are respectively at two ends of the plastic body; the plurality of support blocks also comprise a third support block for isolating the two static contact pieces at two sides in the length direction; the bridge-type movable contact piece is provided between a contact of the normally closed static contact piece and a contact of the common end static contact piece or between a contact of the normally opened end static contact piece and a contact of the common end static contact piece, and the two ends of the bridge-type movable contact piece exceed beyond the corresponding two contacts.

The movable contact part includes two individual units matched on the two sides of the armature part, each of the individual units includes two bridge-type movable contact pieces, one elastic resetting piece, and a plastic piece for combining two bridge-type movable contact pieces and an elastic resetting piece into an integrated structure through an injection molding, the elastic resetting piece and the plastic piece form a cross-shaped structure, and the third support block also encloses a corresponding cross-shaped groove to adapt to up and down movement of the cross-shaped structure formed by the elastic resetting piece and the plastic piece.

The coil part further comprises coil leading-out pins and support feet integrally formed with a coil frame through an injection molding, the plastic body is further provided with slots, the coil leading-out pins of the coil part are inserted and matched into the slots of the plastic body, the support feet of the coil parts are placed on the upper grounding shield piece and are fixed by a glue, a glue storage groove enclosed by a side wall of the groove, a partition plate and the support block is provided in the plastic body corresponding to a position where the support feet and the upper grounding shield piece are glued together.

Hereinafter, the present disclosure will be further described in detail in conjunction with the drawings and the embodiments; however, the high-frequency relay with excellent shielding performance according to the present disclosure is not limited to these embodiments.

### BRIEF DESCRIPTION OF THE DRAWINGS

FIG. 1 is a perspective view of a first embodiment of the present disclosure (excluding a shell);

FIG. 2 is a perspective exploded view of the first embodiment of the present disclosure;

FIG. 3 is a sectional view of the first embodiment of the present disclosure (excluding the shell);

FIG. 4 is a perspective view of a base part and a movable contact part according to the first embodiment of the present disclosure being assembled;

FIG. 5 is a partial exploded view of the base part and the movable contact part according to the first embodiment of the present disclosure;

FIG. 6 is a top view of the base part and the movable contact part according to the first embodiment of the present disclosure being assembled;

FIG. 7 is a sectional view along a line A-A in FIG. 6;

FIG. 8 is a perspective view of the base part (excluding an upper grounding shield piece) being matched with the movable contact part according to the first embodiment of the present disclosure;

FIG. 9 is an enlarged view of a portion B in FIG. 8;

FIG. 10 is a perspective view of the base part (excluding an upper grounding shield piece) according to the first embodiment of the present disclosure;

FIG. 11 is a view of an upper grounding shield piece, a lower grounding shield piece, and static contact pieces according to the first embodiment of the present disclosure being matched;

FIG. 12 is an enlarged view of a portion C in FIG. 11;

FIG. 13 is a view of a strip material composed of the lower grounding shield and the static contact piece according to the first embodiment of the present disclosure.

FIG. 14 is a perspective view of a movable contact part according to a second embodiment of the present disclosure;

FIG. 15 is a perspective view of the movable contact part according to the second embodiment of the present disclosure (excluding a plastic body);

FIG. 16 is a view of a strip material of the movable contact part according to the second embodiment of the present disclosure;

FIG. 17 is a structural view after the strip material of the movable contact part according to the second embodiment of the present disclosure is injection molded;

FIG. 18 is a structural view of stamping an elastic resetting piece after the strip material of the movable contact part according to the second embodiment of the present disclosure is injection molded;

FIG. 19 is an appearance view of the high-frequency relay according to the second embodiment of the present disclosure (excluding the shell);

FIG. 20 is a sectional view of the high-frequency relay according to the second embodiment of the present disclosure (excluding the shell);

FIG. 21 is a perspective exploded view of the high-frequency relay according to the second embodiment of the present disclosure;

FIG. 22 is a partial structural view of the high-frequency relay according to the second embodiment of the present disclosure;

FIG. 23 is a partial exploded view of the high-frequency relay according to the second embodiment of the present disclosure;

FIG. 24 is a structural view of the base coordinate with the movable contact part of the high-frequency relay according to the second embodiment of the present disclosure; and

FIG. 25 is a perspective view of the movable contact part according to a third embodiment of the present disclosure.

### DETAILED DESCRIPTION

Now, the exemplary implementations will be described more completely with reference to the accompanying drawings. However, the exemplary implementations can be implemented in various forms and should not be construed as limiting the implementations as set forth herein. Although terms having opposite meanings such as “up” and “down” are used herein to describe the relationship of one component relative to another component, such terms are used herein only for the sake of convenience, for example, “in the direction illustrated in the figure”. It can be understood that if a device denoted in the drawings is turned upside down, a component described as “above” something will become a component described as “under” something. Other relativity terms, such as “top” and “bottom”, have similar meanings. When a structure is described as “above” another structure, it probably means that the structure is integrally formed on another structure, or, the structure is “directly” disposed on another structure, or, the structure is “indirectly” disposed on another structure through an additional structure.

Words such as “one”, “an/a”, “the”, and “said” are used herein to indicate the presence of one or more elements/component parts/and others. Terms “including”, “comprising”, and “having” have an inclusive meaning which means that there may be additional elements/component parts/and others in addition to the listed elements/component parts/and others. Terms “first”, “second”, “third”, and so forth are used herein only as labels, and they do not limit the number of objects modified after them.

### The First Embodiment

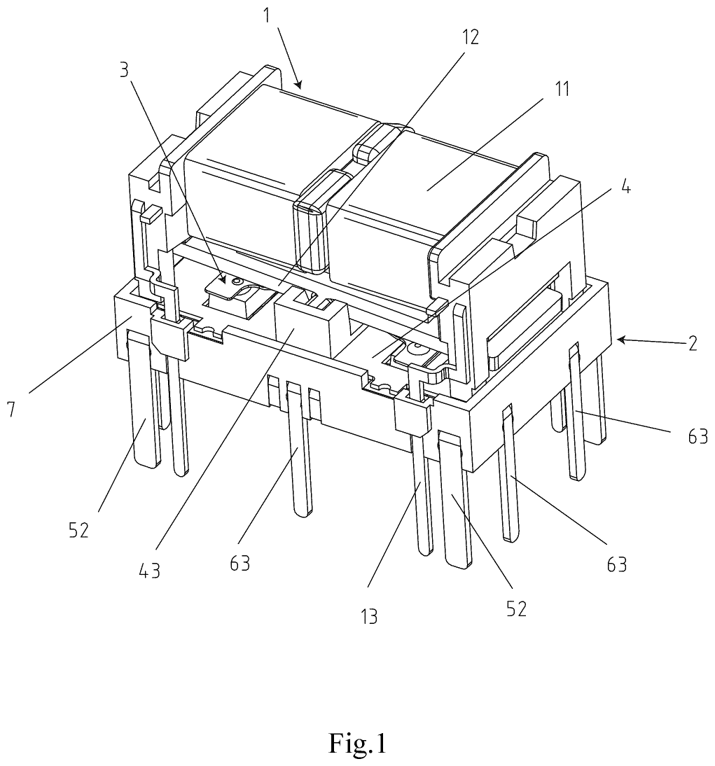

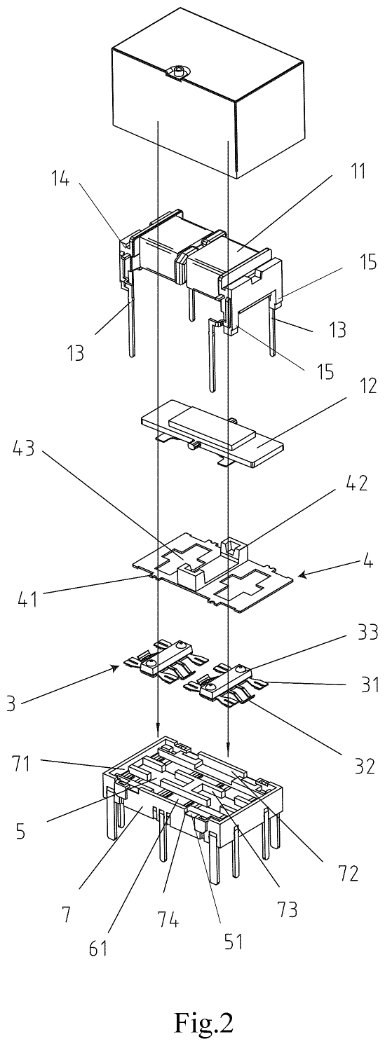

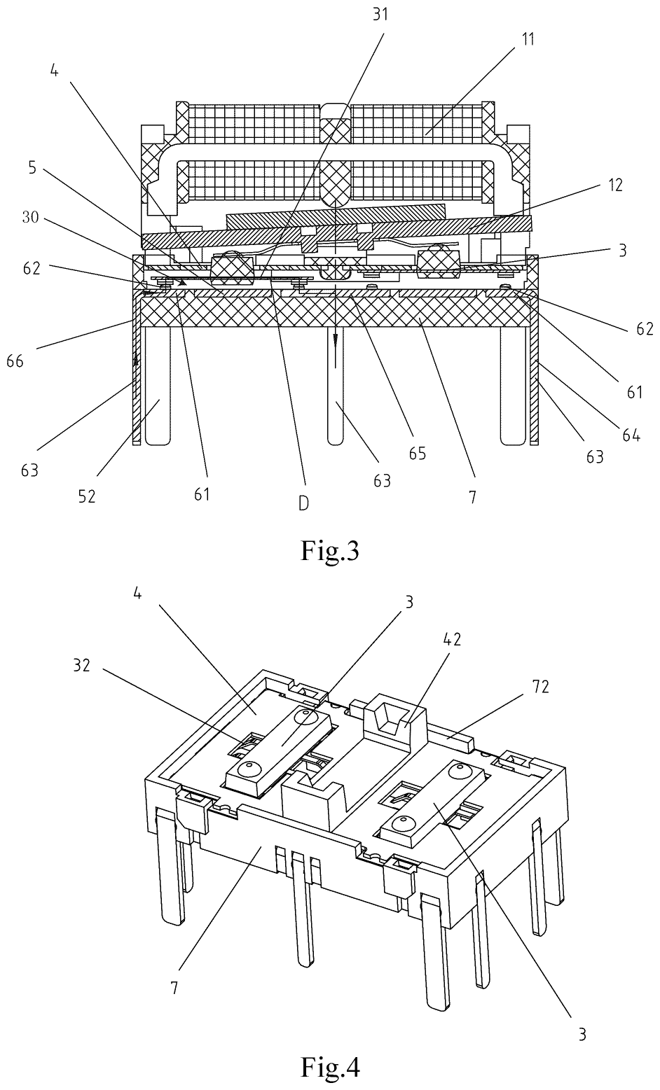

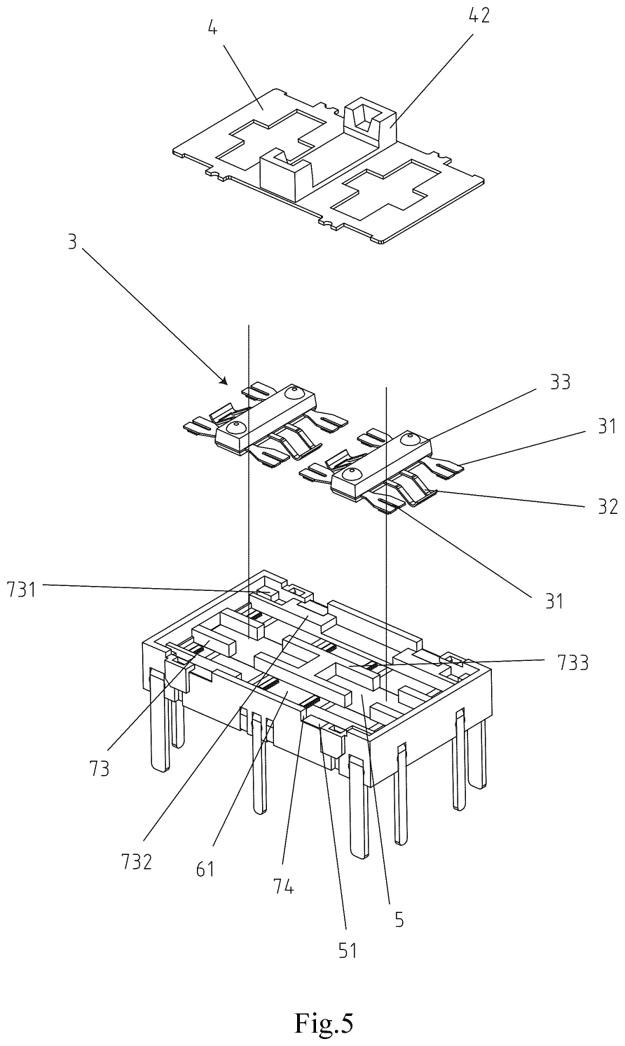

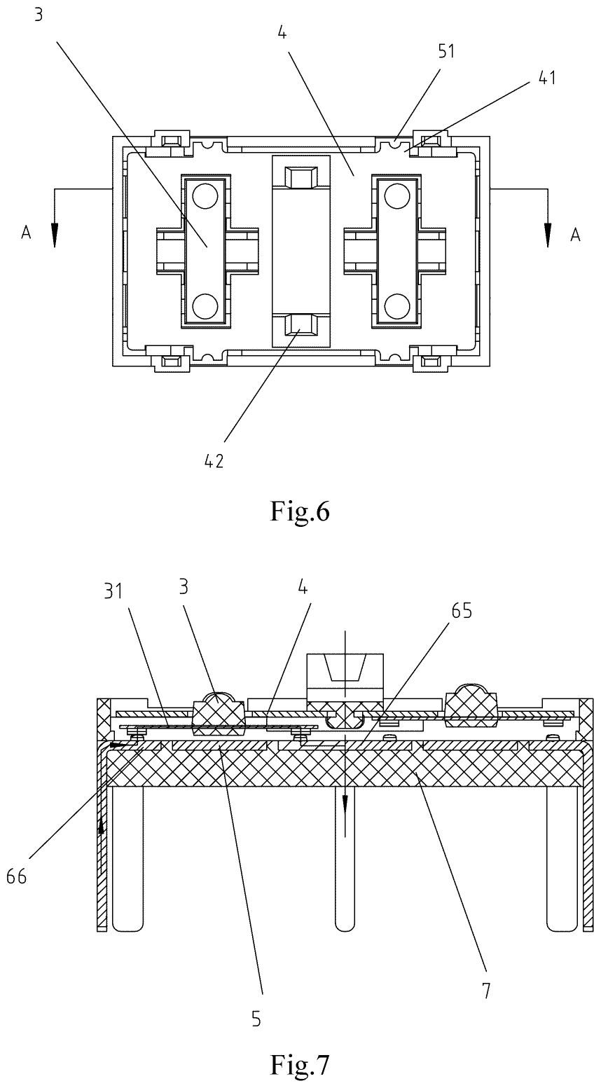

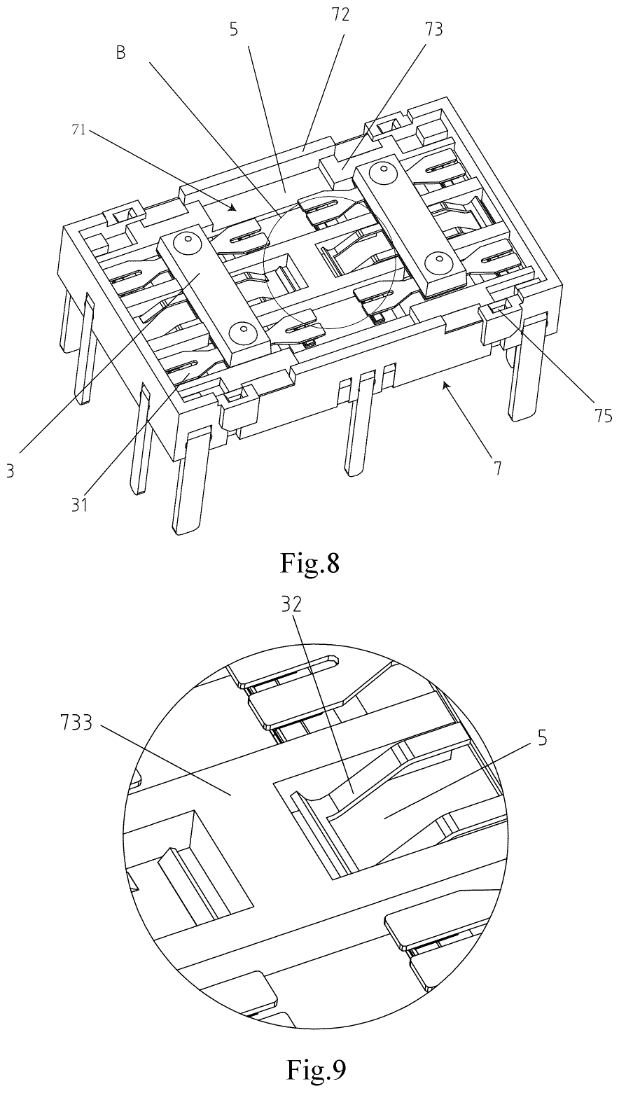

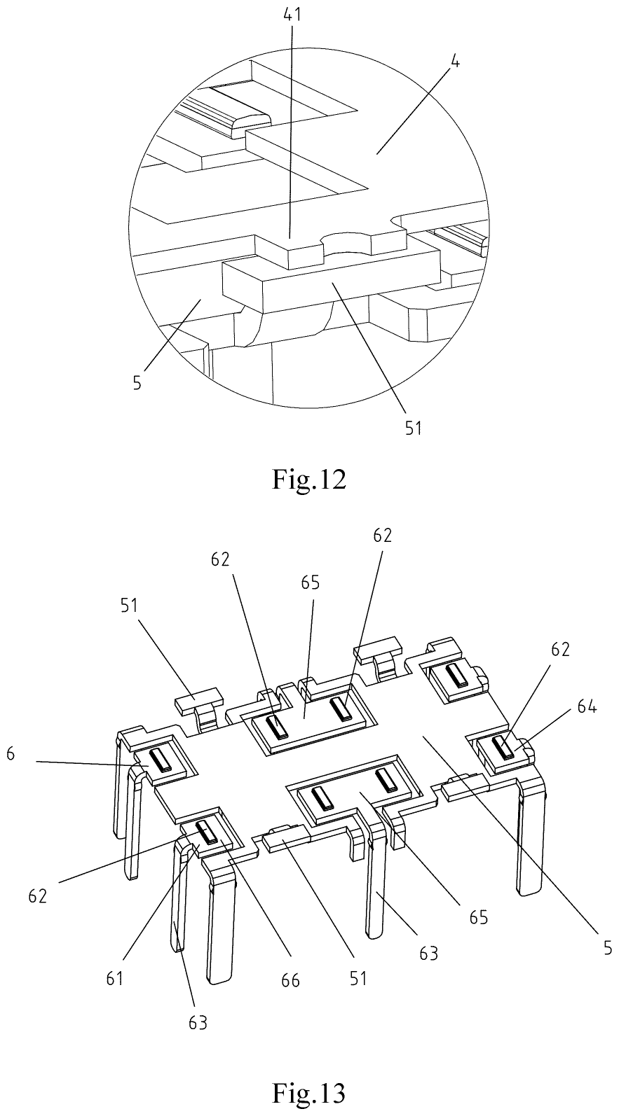

As shown in FIGS. 1-13, a high-frequency relay with excellent shielding performance of the present disclosure includes a magnetic circuit part 1, a base part 2, and a movable contact part 3; the magnetic circuit part 1 and the movable contact part 3 are respectively mounted on the base part 2 and achieve mutual linkage; the base part 2 includes an upper grounding shield piece 4, a lower grounding shield piece 5, at least two static contact pieces 6, and a plastic body 7 combining the lower grounding shield piece 5 and the at least two static contact pieces 6 into an integrated structure through an injection molding; each of the static contact pieces 6 has an exposed portion 61 exposed from a surface of the plastic body 7, and the exposed portion 61 has a contact 62 for contacting with the movable contact part 3, a top surface of the contact 62 is higher than an upper surface of the lower grounding shield piece 5 in a height direction; the upper grounding shield piece 4 is mounted on the plastic body 7 and is higher than the top surface of the contact 62 in the height direction and is grounded through the lower grounding shield piece 5, so that a shielding space 30, which is constituted by a gap between the upper grounding shield piece 4 and the lower grounding shield piece 5 and is capable of accommodating a bridge-type movable contact piece 31 in the movable contact part 3, is formed in the base part 2 (referring to FIG. 3).

In this embodiment, the plastic body 7 is provided with a groove 71, the exposed portion 61 of the static contact piece 6 is at a bottom surface of the groove 71 and is exposed from the bottom surface of the groove 71 of the plastic body 7, and the upper grounding shield piece 4 is mounted in the groove 71 of the plastic body 7.

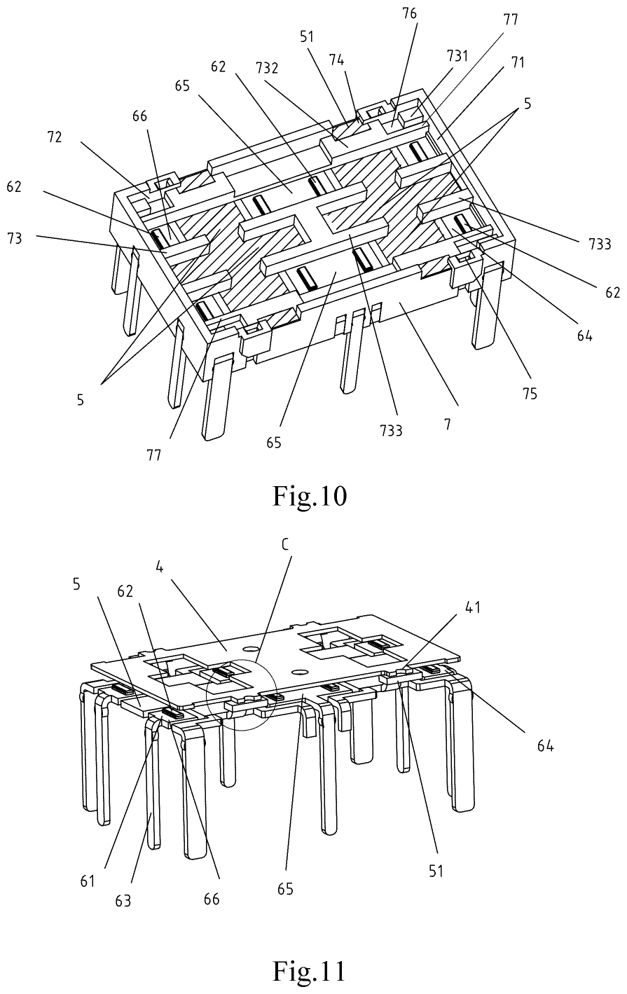

In this embodiment, as shown in FIG. 13, the lower grounding shield piece 5 and the at least two static contact pieces 6 are formed by stamping one strip material, and the lower grounding shield piece 5 and the static contact pieces 6 are combined into the plastic body 7 co-planarly through the injection molding (as shown in FIG. 10), so that the lower grounding shield piece and the static contact pieces form a position complementarity in a plane area.

In this embodiment, the plastic body 7 is a block in a cuboid shape, a periphery of the plastic body 7 extends upward to form side walls 72 and the side walls 72 form the groove 71; the lower grounding shield piece 5 and at least two static contact pieces 6 are co-planarly exposed from the bottom surface of the groove 71 of the plastic body 7.

In this embodiment, in the groove 71 of the plastic body 7, in a covering area corresponding to the lower grounding shield piece 5, a plurality of support blocks 73 integrally connected to the plastic body 7 are provided, the plurality of support blocks 73 respectively cover areas corresponding to the lower grounding shield piece 5; the upper grounding shield piece 4 is placed on the plurality of support blocks 73; a top surface of the side wall 72 is higher than a top surface of the upper grounding shield piece 4.

In this embodiment, the plurality of support blocks 73 comprise first support blocks 731 respectively at four corners of the groove 71 of the plastic body 7 and second support blocks 732 on two long sides of the plastic body in rectangular shape; in the lower grounding shield piece 5, solder pieces 51 extending to two sides are provided, the solder pieces 51 are bent upwards and a top surface of the solder piece is exposed from a top surface of the second support block 732, and the upper grounding shield piece 4 is welded and fixed at a corresponding position with the solder pieces 51 and is grounded through the lower grounding shield piece 5.

In this embodiment, in a long side wall corresponding to the plastic body 7 in rectangular shape, notches 74 are further provided at positions corresponding to the second support blocks 732, solder pieces 51 of the lower grounding shield piece 5 extend to the notches 74, and a height of the top surface of the solder piece 51 in the notch 74 is aligned with a height of the top surface of the second support block 732; in the upper grounding shield piece 4, positioning protrusion pieces 41 integrally extended at positions corresponding to the notches 74 of the plastic body 7 are provided, and the positioning protrusion pieces 41 of the upper grounding shield piece 4 are fit into the notches 74 of the plastic body and are welded and fixed with the solder piece 51.

In this embodiment, each of the lower grounding shield piece 5 and the at least two static contact pieces 6 is respectively provided with a grounding pins or leading-out pins extending outward from a side surface of the plastic body, that is, the lower grounding shield piece 5 is provided with a grounding pins 52, and the static contact piece 6 is provided a leading-out pins 63; wherein the grounding pins 52 of the lower grounding shield piece 5 includes at least four grounding pins 52 distributed at four corners of the plastic body 7 in rectangular shape.

In this embodiment, the movable contact part 3 includes at least one bridge-type movable contact piece 31 linked with the magnetic circuit part 1 and an elastic resetting piece 32 for resetting the bridge-type movable contact piece 31; the bridge-type movable contact piece 31 is in the gap between the upper grounding shield piece 4 and the lower grounding shield piece 5, two ends of the bridge-type movable contact piece 31 correspond to the contacts of two static contact pieces of at least two static contact pieces 6, a lower end of the elastic resetting piece 32 abuts against the lower grounding shield piece 5, such that an upper end of the elastic resetting piece 32 in a resetting process pushes the bridge-type movable contact piece 31 to the upper grounding shield piece 4.

In this embodiment, the magnetic circuit part 1 comprises a coil part 11 and an armature part 12 that cooperate with each other; the coil part 11 is mounted on the plastic body 7, and the armature part 12 is supported by the upper grounding shield piece 4; the upper grounding shield piece 4 is integrally connected to an armature support seat 42 made of plastic materials through the injection molding; there are two armature support seats 42 respectively in a middle position of the two long sides of the upper grounding shield piece 4.

In this embodiment, the at least two static contact pieces include two normally opened end static contact pieces 64, two common end static contact pieces 65, and two normally closed end static contact pieces 66 respectively on the two sides in a length direction of the plastic body in rectangular shape; the two common end static contact pieces 65 are in the middle portion of the long side of the plastic body 7, and the two normally opened end static contact pieces 64 and the two normally closed end static contact pieces 66 are respectively at the two ends of the long side of the plastic body 7; the plurality of support blocks 73 also include a third support block 733 for isolating the two static contact pieces at the two sides in the length direction; the bridge-type movable contact piece 31 is provided between a contact of the normally closed static contact piece 66 and a contact of the common end static contact piece 65 or between a contact of the normally opened end static contact piece 64 and a contact of the common end static contact piece 65, and the two ends of the bridge-type movable contact piece 31 exceed beyond the corresponding two contacts.

In this embodiment, the movable contact part 3 includes two individual units matched on the two sides of the armature part 12, each of the individual units includes two bridge-type movable contact pieces 31, one elastic resetting piece, and a plastic piece 33 for combining two bridge-type movable contact pieces 31 and an elastic resetting piece 32 into an integrated structure through an injection molding, the elastic resetting piece 32 and the plastic piece form a cross-shaped structure, and the third support block 733 also encloses a corresponding cross-shaped groove to adapt to up and down movement of the cross-shaped structure formed by the elastic resetting piece 32 and the plastic piece 33. In the upper grounding shield piece 4, a through-hole 43 is provided to allow the up and down movement of the cross-shaped structure formed by the elastic resetting piece 32 and the plastic piece 33.

In this embodiment, the coil part further comprises a coil leading-out pins 13 and a support feet 15 integrally formed with a coil frame 14 through an injection molding, the plastic body 7 is further provided with a slot 75, the coil leading-out pins 13 of the coil part 11 is inserted and matched into the slot 75 of the plastic body 7, the support feet 15 of the coil part 11 is placed on the upper grounding shield piece 4 and is fixed by a glue, and a glue storage groove 76 enclosed by a side wall 72 of the groove, the partition plate 77 and the support block (i.e., the first support block 731 and the second support block 732) is provided in the plastic body 7 corresponding to a position where the support feet 15 and the upper grounding shield piece 4 are glued together.

According to the high-frequency rely with excellent shielding performance of the present disclosure, the base part 2 includes an upper grounding shield piece 4, a lower grounding shield piece 5, at least two static contact pieces 6, and a plastic body 7 that combines the lower grounding shield piece 5 and at least two static contact pieces 6 into an integrated structure through the injection molding; the static contact pieces 6 have an exposed portion 61 exposed from a surface of the plastic body 7, and the exposed portion 61 has contacts 62 for contacting with the movable contact, a top surface of the contact is higher than an upper surface of the lower grounding shield piece 5 in a height direction; the upper grounding shield piece 4 is mounted on the plastic body 7 and is higher than a top surface of the contact 62 in the height direction and is grounded through the lower grounding shield piece 5, thereby forming a shielding space 30, which is constituted by a gap between the upper grounding shield piece 4 and the lower grounding shield piece 5 and can accommodate the bridge-type movable contact piece 31 in the movable contact part, in the base part 2. This structure of the present disclosure can form a shielding space 30 that is grounded above and below (as shown by D path in FIG. 3), corresponding to a portion for transmitting signals inside the relay, which has a good shielding effect and is characterized by a simple molding process, easy implementation, good processing accuracy, and high assembly and production efficiency.

According to the high-frequency rely with excellent shielding performance of the present disclosure, the lower grounding shield piece 5 and the at least two static contact pieces 6 are formed by stamping one strip material, and the lower grounding shield piece 5 and the static contact pieces 6 are combined into the plastic body 7 co-planarly through the injection molding, so that the lower grounding shield piece 5 and the static contact pieces 6 form a position complementarity in a plane area. According to the structure of the present disclosure, a static contact piece of a signal transmission part (i.e., the portion of the static contact piece containing the contact 62) is co-planar with and spaced from the lower grounding shield piece 5, impedance matching between the signal transmission part and the lower grounding shield piece 5 can be formed, enabling almost distortion-free transmission of high-frequency signals.

According to the high-frequency rely with excellent shielding performance of the present disclosure, in the groove 71 of the plastic body 7, in a covering area corresponding to the lower grounding shield piece 5, a plurality of support blocks 73 integrally connected to the plastic body 7 are provided, the plurality of support blocks 73 respectively cover areas corresponding to the lower grounding shield piece 5; the upper grounding shield piece 4 is placed on the plurality of support blocks 73; a top surface of the side wall 72 is higher than a top surface of the upper grounding shield piece 4. According to the structure of the present disclosure, the plurality of support blocks 73 are used to improve the planarity of the upper grounding shield piece 4 after being assembled, ensuring consistent characteristic impedance, enhancing the transmission performance of high-frequency signals, and also conducive to the planarity of the armature part and a core in a horizontal direction after the coil part is assembled, ensuring the reliability of the relay; the side wall 72 being higher than the upper grounding shield piece 4 can enhance the sealing performance of the relay.

According to the high-frequency rely with excellent shielding performance of the present disclosure, since a lower end of the elastic resetting piece 32 abuts against the lower grounding shield piece 5, such that an upper end of the elastic resetting piece 32 in a resetting process pushes the bridge-type movable contact piece 31 to the upper grounding shield piece 4. According to the structure of the present disclosure, a reaction mechanism of the movable contact part (i.e., an elastic resetting part) is always connected with the lower grounding shield piece 5, to avoid the impact of irregular shapes on high-frequency performance, and improve the mechanical life and reliability of the relay.

In addition, a high-frequency relay is a relay for switching high-frequency circuits. A high-frequency relay in existing technology typically includes a magnetic circuit part, a base part, and a movable contact part. In such high-frequency relay, a static contact part is integrated within the base to form a base part. The magnetic circuit part is mounted on the base part, an armature in the magnetic circuit part has a seesaw structure that cooperates with the movable contact part mounted into the base. The base is provided with a groove, and the movable contact part includes a movable contact assembly and a reaction spring. The movable contact assembly is mounted in the base by a reaction spring. When one end of the armature actuates downwards to press the movable contact assembly, the movable contact assembly overcomes an elastic force of the reaction spring to allow the bridge-type movable contact piece in the movable contact assembly to be movable downward in the groove, and the two ends of the bridge-type movable contact piece are in contact with the contacts on the two static contact pieces, so that the circuits connected by the static contact pieces are closed. When the armature actuates upward, the movable contact assembly, under the action of the elastic force of the reaction spring, to allow the bridge-type movable contact piece in the movable contact assembly to be movable upward in the groove, and the two ends of the bridge-type movable contact pieces are separated from the contacts on the two static contact pieces, so that the circuits connected by the static contact pieces are opened. The movable contact assembly of the movable contact part and the reaction spring in the existing technology are two separate parts, resulting in numerous parts of the movable contact parts, poor assembly stability, low material utilization, and high manufacturing costs.

The present disclosure also provides a movable contact part for high-frequency signal transmission and its high-frequency relay, which has characteristics: having fewer parts, good structural strength, good assembly stability, high material utilization, and low production cost.

A technical solution adopted by the present disclosure to solve the technical problem is: a movable contact part for high-frequency signal transmission, including a first piece body, a second piece body, and a plastic body that encapsulates middle portions of the first piece body and the second piece body disconnected with each other through an injection molding to form an integrated structure therein; the first piece body is designed as a bridge-type movable contact piece of the movable contact part; the second piece body has two ends bent to form a protruded part downward, thereby forming an elastic resetting piece of the movable contact part.

The first piece body and the second piece body are formed by stamping on one strip material; the two ends of the first piece body are stamped to form the bridge-type movable contact piece; the two ends of the second piece body are stamped and bent to form the protruded part downward, thereby forming the elastic resetting piece.

The plastic body is in a strip shape and is distributed perpendicular to the first piece body on the same plane.

A protrusion for cooperating with the armature part of the relay is provided on the upper surface of the plastic body.

The strip material is in a rectangular shape, and the first piece body and the second piece body are arranged side by side simultaneously in a length direction or in a width direction of the strip material.

There are two first piece bodies and one second piece body; in the side-by-side arrangement, the one second piece body is in the middle of two first piece bodies; the one second piece body and the plastic body together form a cross-shaped structure.

There is one first piece body and two second piece bodies; in the side-by-side arrangement, the one first piece body is in the middle of the two second piece bodies; the two second piece bodies and the plastic body together form an I-shaped structure.

The second piece body is of a frame shape, and the plastic body is filled to a part of a central through hole of the frame of the second piece body.

A high-frequency relay includes a magnetic circuit part, a base part, and the aforementioned movable contact part; the magnetic circuit part is mounted on the base part; the base part is provided with a groove into which the movable contact part is adapted to be mounted, and the movable contact piece is inserted into the groove by virtue of the elastic characteristic of the elastic resetting piece, and the bridge-type movable contact piece of the movable contact part is limited between the contacts of the static contact of the base part and an upper shield piece, and an armature part of the magnetic circuit part is cooperated with the plastic body of the movable contact part.

A plurality of support blocks are provided within the groove of the base part, and enclose a cross-shaped or I-shaped groove adapted for the insertion of the plastic body and the second piece body of the movable contact part.

The magnetic circuit part also includes a coil part that cooperates with the armature part; the coil part is mounted on the base part, and the armature part is in a seesaw shape and cooperates with the coil part.

Compared with the existing technology, the advantageous effects of the present disclosure are:

In the present disclosure, the first piece body, the second piece body, and the plastic body that encapsulates middle portions of the first piece body and the second piece body disconnected with each other through an injection molding to form an integrated structure therein; the first piece body is designed as a bridge-type movable contact piece of the movable contact part; the second piece body has two ends bent to form a protruded part downward, thereby forming an elastic resetting piece of the movable contact part. The structure of the present disclosure has characteristics: fewer parts, good structural strength, good assembly stability, high material utilization, and low production cost.

### The Second Embodiment

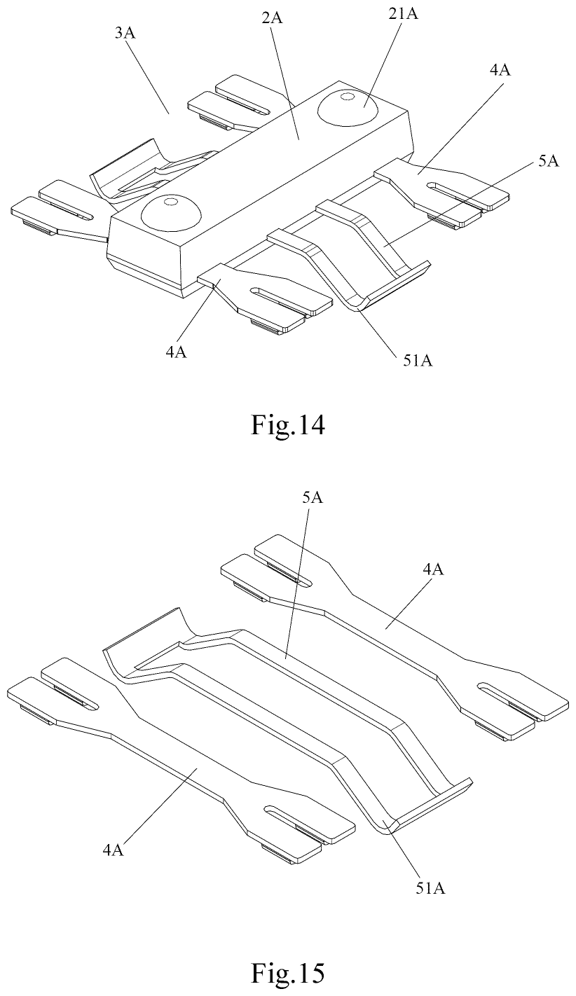

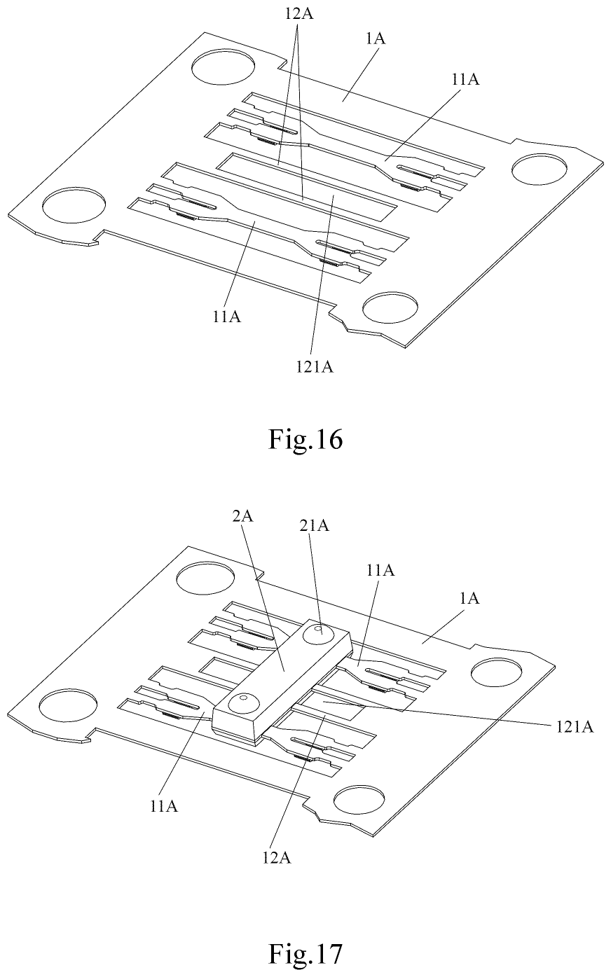

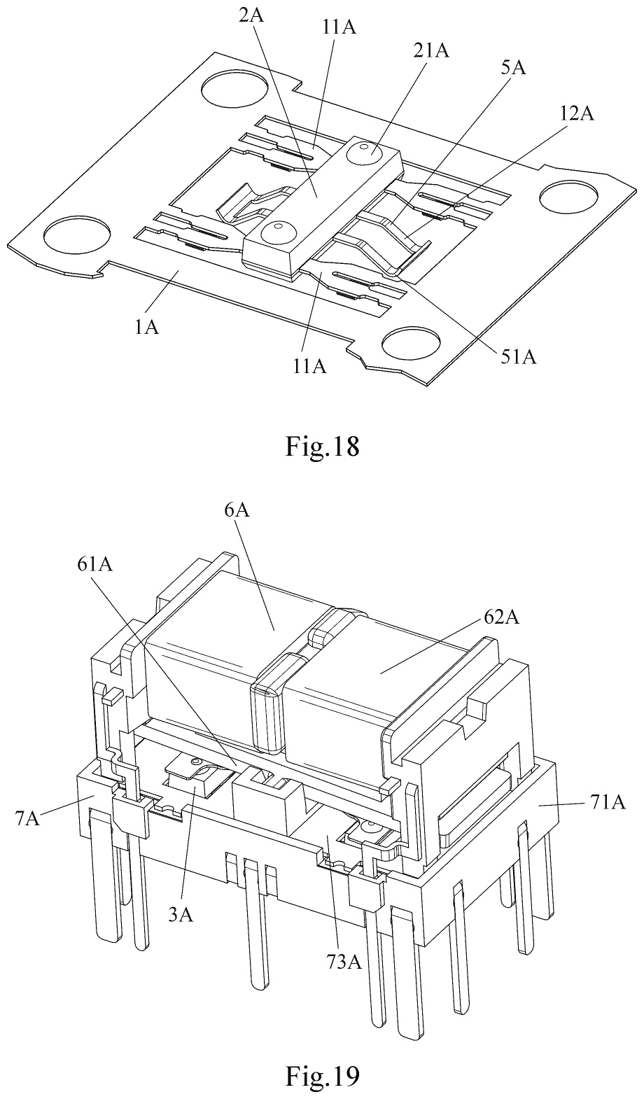

As shown in FIGS. 14-18, the movable contact part for high-frequency signal transmission includes a first piece body 11A and a second piece body 12A, which are formed on one strip material 1A by stamping and a plastic body 2A that encapsulates middle portions of the first piece body 11A and the second piece body 12A disconnected with each other through an injection molding to form an integrated structure therein; the first piece body 11a is designed as a bridge-type movable contact piece 4A of the movable contact part 3A; elastic resetting piece 5A of the movable contact part 3A is formed after the second piece body 12A is stamped and bent at the two ends to form a protruded part 51A downward.

In this embodiment, the plastic body 2A is in a strip shape and is distributed perpendicular to the first piece body on the same plane.

In this embodiment, a protrusion 21A for cooperating with the armature part of the relay is provided on the upper surface of the plastic body 2A.

In this embodiment, the strip material 1A is in rectangular shape, and the first piece body 11A and the second piece body 12A are arranged side by side simultaneously in a length direction or in a width direction of the strip material.

In this embodiment, there are two first piece bodies 11A and one second piece body 12A; in the side-by-side arrangement, the one second piece body 12A is in the middle of two first piece bodies 11A; the one second piece body 12A and the plastic body 2A together form a cross-shaped structure. After a stamping process, the movable contact part 3A includes two bridge-type movable contact pieces 4A, one elastic resetting piece 5A, and a plastic body 2A that encapsulates the two bridge-type movable contact pieces 4A and one elastic resetting piece 5A into an integrated structure through the injection molding. The plastic body 2A is provided with two protrusions 21A for cooperating with the armature part of the relay.

In this embodiment, the second piece body 12A is of a frame shape, and the plastic body 2A is filled to a part of a central through hole 121A of the frame of the second piece body 12A.

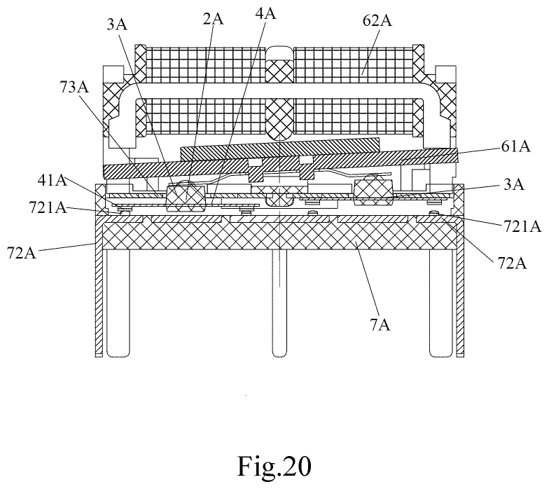

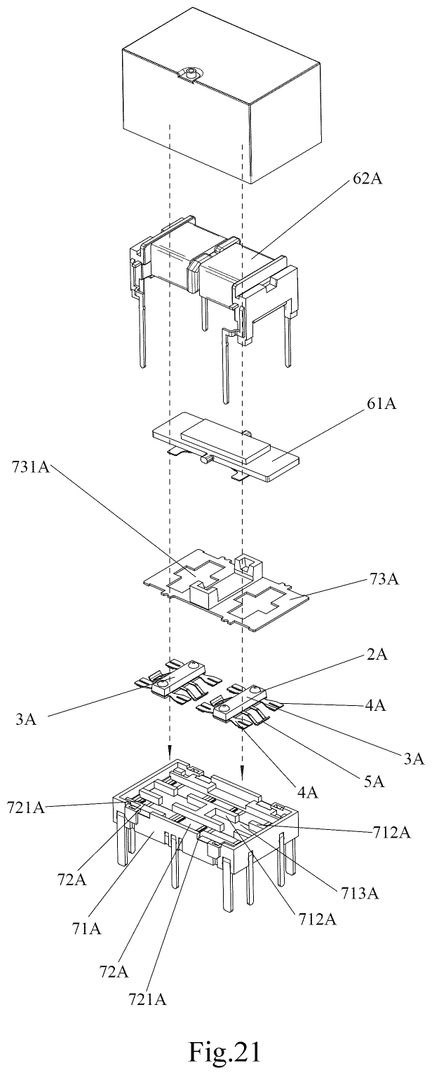

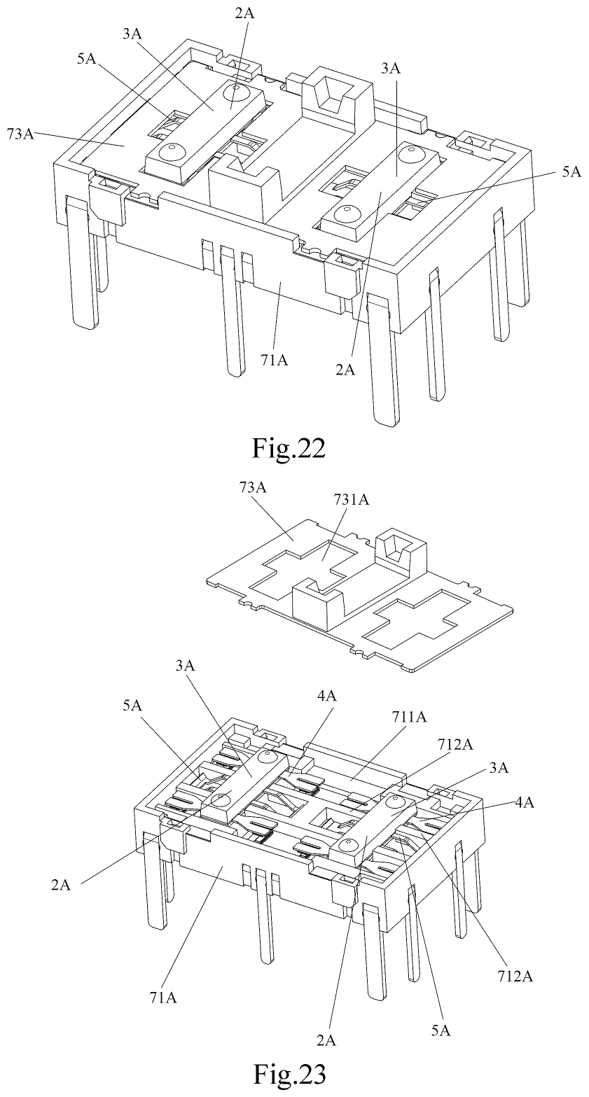

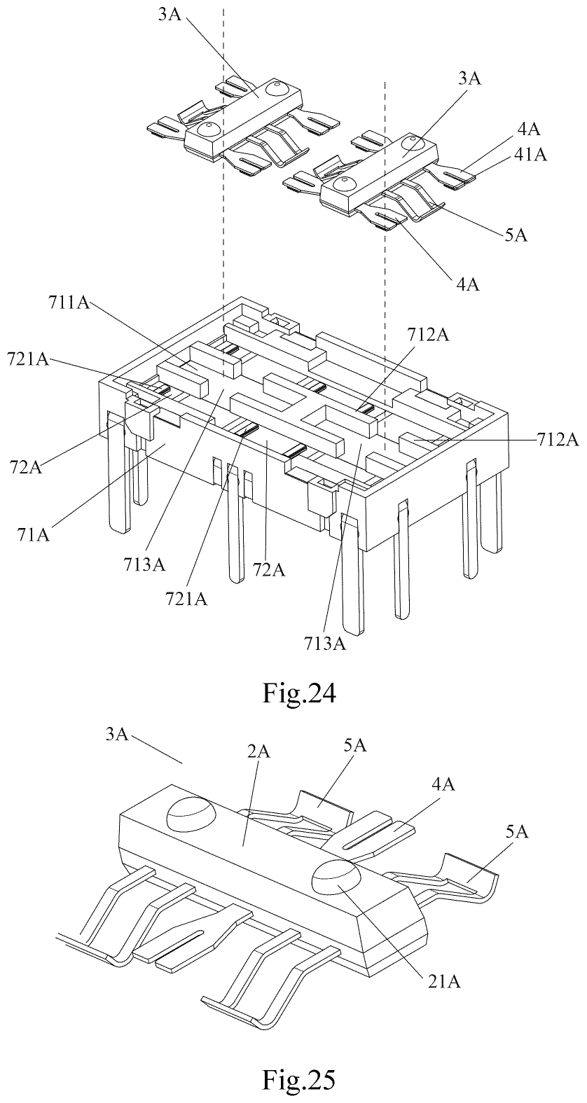

As shown in FIGS. 14 to 24, a high-frequency relay of the present disclosure includes a magnetic circuit part 6A, a base part 7A, and the aforementioned movable contact part 3A; the base part 7A includes a base 71A, a static contact piece 72A having static contacts 721A, and an upper shield piece 73A, wherein the static contact piece 72A is embedded in the base 71A through the injection molding; the magnetic circuit part 6A is mounted on the base part 7A; the base part 7A is provided with a groove 711A in which the movable contact part 3A is adapted to mount, that is, the base 71A is provided with a grove 711A in which the movable contact part 3A is adapted to mount, the movable contact part 3A is mounted into the groove 711A through an elastic characteristic of the elastic resetting piece 5A, and the bridge-type movable contact piece 4A of the movable contact part 3A is limited between the contacts 721A of the static contact of the base part and the upper shield piece 73A, the armature part 61A of the magnetic circuit part 6A cooperates with the plastic body 2A of the movable contact part 3A.

In this embodiment, a plurality of support blocks 712A are provided within the groove 711A of the base part 7A, that is, a plurality of support blocks 712A is provided within the groove 711A of the base 71A, the plurality of support blocks 712A enclose a cross-shaped groove 713A adapted for the insertion of the plastic body 2A of the movable contact part 3A and the elastic resetting piece 5A.

In this embodiment, the upper shield piece 73A is a grounding shield piece as a whole, the upper shield piece 73A is mounted in the groove 711A of the base 71A. The upper shield 73A is provided with the cross-shaped avoidance hole 731A for the up and down movement of the plastic body 2A and the elastic resetting piece 5A of the movable contact part 3A.

In this embodiment, the magnetic circuit part 6A also includes a coil part 62A that cooperates with the armature part 61A; the coil part 62A is mounted on the base part 7A, and the armature part 61A is in a seesaw shape and cooperates with the coil part 62A.

The movable contact part for high-frequency signal transmission and the high-frequency relay thereof according to the present disclosure includes a first piece body 11A and a second piece body 12A, which are formed on one strip material 1A by stamping, and a plastic body 2A that encapsulates middle portions of the first piece body 11A and the second piece body 12A disconnected with each other through an injection molding to form an integrated structure therein; the first piece body 11a is designed as a bridge-type movable contact piece 4A of the movable contact part 3A; the elastic resetting piece 5A of the movable contact part 3A is formed after the second piece body 12A is stamped and bent at the two ends to form a protruded part 51A downward. According to the structure of the present disclosure, the movable contact piece (i.e., the bridge-type movable contact piece 4A) and a retraction mechanism (i.e., the elastic resetting piece 5A) are provided on one strip material, the movable contact piece and the retraction mechanism are in the same direction, The waste materials between the movable contact bands are fully used to be stamped to form a reaction spring structure, and then combine with the movable contact piece into an integrated structure. This can reduce the number of assembly parts and improve material utilization. As the movable contact piece and the retraction mechanism are in the same direction, after stamping, the retraction mechanism becomes planar and is bent using the space on the two sides of the plastic piece (i.e., the plastic body 2A) to form a retraction mechanism with elasticity. The present disclosure has characteristics: fewer parts, good structural strength, good assembly stability, high material utilization, and low production cost.

### The Third Embodiment

As shown in FIG. 25, a movable contact part for high-frequency signal transmission and its high-frequency relay according to the present disclosure differ from that in the second embodiment that, in this embodiment, there is one first piece body 11A and two second piece bodies 12A; in the side-by-side arrangement, one first piece 11A is in the middle of the two second piece bodies 12A; the two second pieces 12A and the plastic body 2A together form an I-shaped structure. After stamping, the movable contact part 3A includes one bridge-type movable contact piece 4A, two elastic resetting pieces 5A, and a plastic body 2A that injects one bridge-type movable contact piece 4A and two elastic resetting pieces 5A into an integrated structure, and the plastic body 2A is provided with two protrusions 21A for cooperating with the armature part of the relay.

It should be understood that this disclosure would never be limited to the detailed construction and arrangement of components as set forth in this specification. The present disclosure has other implementations that are able to be practiced or carried out in various ways. The foregoing variations and modifications fall within the scope of this disclosure. It should be understood that the present disclosure would contain all alternative combination of two or more individual features as mentioned or distinguished from in the text and/or in the drawings. All of these different combinations constitute a number of alternative aspects of the present disclosure. The implementations as illustrated in this specification are the best modes known to achieve the present disclosure and will enable the person skilled in the art to realize the present disclosure.

1. A high-frequency relay with excellent shielding performance, comprising:
a magnetic circuit part, a base part, and a movable contact part, the magnetic circuit part and the movable contact part being respectively mounted on the base part and achieving mutual linkage, wherein:
the base part comprises an upper grounding shield piece, a lower grounding shield piece, at least two static contact pieces, and a plastic body combining the lower grounding shield piece and the at least two static contact pieces into an integrated structure through an injection molding;
each of the static contact pieces has an exposed portion exposed from a surface of the plastic body, and the exposed portion has a contact for contacting with the movable contact part, a top surface of the contact is higher than an upper surface of the lower grounding shield piece in a height direction; and
the upper grounding shield piece is mounted on the plastic body and is higher than the top surface of the contact in the height direction and is grounded through the lower grounding shield piece, so that a shielding space is formed in the base part, and the shielding space is constituted by a gap between the upper grounding shield piece and the lower grounding shield piece and is capable of accommodating a bridge-type movable contact piece in the movable contact part.

2. The high-frequency relay with excellent shielding performance according to claim 1, wherein the plastic body is provided with a groove, the exposed portion of the static contact piece is at a bottom surface of the groove and is exposed from a bottom surface of the groove of the plastic body, the upper grounding shield piece is mounted in the groove of the plastic body.

3. The high-frequency relay with excellent shielding performance according to claim 1, wherein the lower grounding shield piece and the at least two static contact pieces are formed by stamping one strip material, and the lower grounding shield piece and the static contact pieces are combined into the plastic body co-planarly through the injection molding, so that the lower grounding shield piece and the static contact pieces form a position complementarity in a plane area.

4. The high-frequency relay with excellent shielding performance according to claim 3, wherein the plastic body is a block in a cuboid shape, a periphery of the plastic body extends upward to form side walls and the side walls form the groove; the lower grounding shield piece and at least two static contact pieces are co-planarly exposed from the bottom surface of the groove of the plastic body.

5. The high-frequency relay with excellent shielding performance according to claim 4, wherein in the groove of the plastic body, in a covering area corresponding to the lower grounding shield piece, a plurality of support blocks integrally connected to the plastic body are provided, the plurality of support blocks respectively cover areas corresponding to the lower grounding shield piece; the upper grounding shield piece is placed on the plurality of support blocks; a top surface of the side wall is higher than a top surface of the upper grounding shield piece.

6. The high-frequency relay with excellent shielding performance according to claim 5, wherein the plurality of support blocks comprise first support blocks respectively at four corners of the groove of the plastic body and second support blocks on two long sides of the plastic body in a rectangular shape; in the lower grounding shield piece, solder pieces extending to two sides are provided, the solder pieces are bent upwards and top surfaces of the solder pieces are exposed from a top surfaces of the second support blocks, and the upper grounding shield piece is welded and fixed at a corresponding position with the solder pieces.

7. The high-frequency relay with excellent shielding performance according to claim 6, wherein in long side walls corresponding to the plastic body in a rectangular shape, notches are further provided at a position corresponding to the second support blocks, the solder pieces of the lower grounding shield piece extend to the notches, and a height of the top surface of the solder piece in the notch is aligned with a height of the top surface of the second support block; in the upper grounding shield piece, positioning protrusion pieces integrally extended at a positions corresponding to the notches of the plastic body are provided, and the positioning protrusion pieces of the upper grounding shield piece are fit into the notch of the plastic body and are welded and fixed with the solder piece.

8. The high-frequency relay with excellent shielding performance according to claim 4, wherein the lower grounding shield piece and the at least two static contact pieces are respectively provided with grounding pins or leading-out pins extending outward from a side surface of the plastic body; wherein the grounding pins of the lower grounding shield piece comprises at least four grounding pins distributed at four corners of the plastic body in a rectangular shape.

9. The high-frequency relay with excellent shielding performance according to claim 4, wherein the movable contact part comprises at least one bridge-type movable contact piece linked with the magnetic circuit part and an elastic resetting piece for resetting the bridge-type movable contact piece; the bridge-type movable contact piece is in the gap between the upper grounding shield piece and the lower grounding shield piece, two ends of the bridge-type movable contact piece respectively correspond to the contacts of two static contact pieces of at least two static contact pieces, a lower end of the elastic resetting piece abuts against the lower grounding shield piece, such that an upper end of the elastic resetting piece in a resetting process pushes the bridge-type movable contact piece to the upper grounding shield piece.

10. The high-frequency relay with excellent shielding performance according to claim 4, wherein the magnetic circuit part comprises a coil part and an armature part that cooperate with each other; the coil part is mounted on the plastic body, and the armature part is supported by the upper grounding shield piece; the upper grounding shield piece is integrally connected to an armature support seat through the injection molding; there are two armature support seats respectively in a middle position of two long sides of the upper grounding shield piece.

11. The high-frequency relay with excellent shielding performance according to claim 6, wherein the at least two static contact pieces comprise two normally opened end static contact pieces, two common end static contact pieces, and two normally closed end static contact pieces respectively on two sides in a length direction of the plastic body in rectangular shape; the two common end static contact pieces are in a middle portion of the plastic body, and the two normally opened end static contact pieces and the two normally closed end static contact pieces are respectively at two ends of the plastic body; the plurality of support blocks also comprise a third support block for isolating the two static contact pieces at two sides in the length direction; the bridge-type movable contact piece is provided between a contact of the normally closed static contact piece and a contact of the common end static contact piece or between a contact of the normally opened end static contact piece and a contact of the common end static contact piece, and the two ends of the bridge-type movable contact piece exceed beyond the corresponding two contacts.

12. The high-frequency relay with excellent shielding performance according to claim 9, wherein the movable contact part comprises two individual units matched on two sides of the armature part, each of the individual units comprises two bridge-type movable contact pieces, an elastic resetting piece, and a plastic piece for combining the two bridge-type movable contact pieces and the elastic resetting piece into an integrated structure through an injection molding, the elastic resetting piece and the plastic piece form a cross-shaped structure, and the third support block also encloses a corresponding cross-shaped groove to adapt to an up and down movement of the cross-shaped structure formed by the elastic resetting piece and the plastic piece.

13. The high-frequency relay with excellent shielding performance according to claim 9, wherein the coil part further comprises coil leading-out pins and support feet integrally formed with a coil frame through an injection molding, the plastic body is further provided with slots, the coil leading-out pins of the coil part are inserted and matched into the slots of the plastic body, the support feet of the coil parts are placed on the upper grounding shield piece and are fixed by a glue, a glue storage groove enclosed by a side wall of the groove, a partition plate and the support block is provided in the plastic body corresponding to a position where the support feet and the upper grounding shield piece are glued together.

14. The high-frequency relay with excellent shielding performance according to claim 2, wherein the lower grounding shield piece and the at least two static contact pieces are formed by stamping one strip material, and the lower grounding shield piece and the static contact pieces are combined into the plastic body co-planarly through the injection molding, so that the lower grounding shield piece and the static contact pieces form a position complementarity in a plane area.
